(19) United States
(12) Patent Application Publication
(10) Pub. No.: US 2026/0319988 A1
(43) Pub. Date: Oct. 15, 2026

(54) INTELLIGENT BRIDGE DEVICE AND SYSTEM FOR IMPARTING AGENT FUNCTIONALITY TO ELECTRONIC DEVICES, EQUIPMENT, AND APPLIANCES

(71) Applicant: Brian Krejcarek, Austin, TX (US)

(72) Inventor: Brian Krejcarek, Austin, TX (US)

(21) Appl. No.: 19/643,664

(22) Filed: Apr. 9, 2026

Related U.S. Application Data
(60) Provisional application No. 63/786,678, filed on Apr. 10, 2025.

(51) Int. Cl. G06F 13/40

(52) U.S. Cl. CPC G06F 13/4027; G06F 2213/40

(57) ABSTRACT

Embodiments include an intelligent bridge device that imparts agent functionality, machine intelligence, and network connectivity to electronic devices that lack native AI capabilities. The bridge device may be portable or embedded and includes wide-area connectivity, such as cellular, along with local interfaces including USB, Bluetooth, Wi-Fi, or wired serial connections. The device can identify, interrogate, learn, configure, and operate connected equipment using protocol discovery, interface probing, driver generation, model inference, sensor input, and policy-based agent execution. Using the described embodiments, conventional devices such as printers, routers, appliances, vehicles, or industrial equipment become addressable, voice-accessible, context-aware, and remotely manageable agent endpoints.

### CROSS-REFERENCE TO RELATED APPLICATIONS

This application claims the benefit of priority of U.S. Provisional Application No. 63/786,678 filed on Apr. 10, 2025 entitled “Portable Voice-Interactive AI Communication System and Method,” content of which is incorporated herein by reference in its entirety and should be considered a part of this specification.

### BACKGROUND

### Field

This invention relates generally to the fields of artificial intelligence and enabling artificial intelligence capability to electronic devices, lacking built-in artificial intelligence hardware, software or capability.

### Description of the Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Many electronic devices, appliances, instruments, and pieces of equipment presently include one or more local communication interfaces, such as USB ports, Bluetooth radios, Wi-Fi connectivity, wired serial interfaces, or other data interfaces. However, despite the widespread presence of such interfaces, many such devices remain operationally limited. They often require manual setup, vendor-specific drivers, dedicated applications, user training, or static control software. In many cases, they are not naturally accessible through conversational systems, intelligent agents, or interoperable machine-to-machine frameworks.

For example, printers commonly require installation of drivers, network discovery steps, operating-system-specific setup, and explicit application workflows before a user may perform a simple print task. Home routers, test equipment, appliances, and industrial devices similarly may expose some interface but remain difficult to configure, troubleshoot, automate, or coordinate with other systems. Even where connectivity exists, the device itself does not possess agency in the sense of being able to interpret intent, collaborate with other devices, interact naturally with users, or participate in broader intelligent workflows.

At the same time, recent advances in large language models, cloud-based agents, and multimodal software systems have made it possible for users to interact with software in increasingly natural ways, including spoken requests, conversational troubleshooting, and delegated task execution. However, such capabilities are not readily transferable to the vast installed base of ordinary electronic devices. Existing approaches typically require redesigning the device itself, building custom firmware, adding a full embedded computer into the product, or relying on fragmented smart-home, vehicle, or industrial IoT ecosystems with narrow compatibility.

A need therefore exists for a device and system capable of serving as an intelligent bridge between otherwise conventional electronics and cloud-based intelligence. A need further exists for a solution that can make existing devices accessible to agents, can endow such devices with contextual awareness through supplemental sensing, can support voice-first interaction, can securely mediate access and identity, and can enable collaboration among multiple devices and multiple agents. A further need exists for an architecture in which a supervisory agent can coordinate specialized subordinate agents and manage handoff, identity, and session continuity on behalf of an end user.

### SUMMARY

The appended claims may serve as a summary of this application. Further areas of applicability of the present disclosure will become apparent from the detailed description, the claims, and the drawings. The detailed description and specific examples are intended for illustration only and are not intended to limit the scope of the disclosure.

### BRIEF DESCRIPTION OF THE DRAWINGS

These drawings and the associated description herein are provided to illustrate specific embodiments of the invention and are not intended to be limiting.

FIG. 1 is a block diagram illustrating an example system architecture in which an intelligent bridge device couples one or more connected things to cloud-based agents, policy services, and remote intelligence.

FIG. 2 is a flow diagram illustrating an example process for discovery of a connected thing, inference of its capabilities, construction of an agent-usable interface, and execution of a requested task.

FIG. 3 is a block diagram illustrating supervisory-agent and subordinate-agent handoff, including session management, scoped permissions, and return of control.

FIG. 4 is a flow diagram illustrating handling of voice interaction in a shared environment, including multiple-speaker detection, active-user determination, restricted-mode operation, and escalated verification for privileged actions.

FIG. 5 is a block diagram illustrating an embodiment in which the intelligent bridge device functions as a key, credential, or secure capability-unlocking intermediary for a connected thing, including a vehicle.

FIG. 6 is a flow diagram illustrating an example voice-first security and authentication process including risk classification, challenge escalation, scoped authorization, and session monitoring.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements. Some of the embodiments or their aspects are illustrated in the drawings.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

### Various Aspects of the Embodiments

In one aspect, the described embodiments provide an intelligent bridge device and associated methods for imparting agent functionality to electronic devices, appliances, machines, instruments, and other physical things (collectively referred to as “thing” or “things”). The bridge device includes a wide-area communications interface, such as cellular connectivity, and one or more local interfaces, such as USB, Bluetooth, Wi-Fi, Ethernet, or serial, enabling the bridge device to communicatively couple a physical thing to one or more remote software agents, large language models, or cloud intelligence systems.

In various embodiments, the bridge device identifies and learns the connected thing, determines its capabilities, constructs or selects an operable interface, and enables the thing to be controlled, queried, monitored, or collaborated with as an intelligent agent endpoint. The bridge device may further include sensors providing contextual awareness not native to the thing itself. In some embodiments, a supervisory agent manages user interaction and selectively hands off tasks to specialized subordinate agents while preserving session boundaries, permissions, and user clarity.

In further embodiments, the bridge device supports dynamic role assignment, so that the same physical bridge hardware may morph into different operational roles depending on attached equipment, sensed environment, available agents, permissions, or user request. In additional embodiments, the bridge device serves as a secure key, credential, or capability-unlocking tool for connected things, including vehicle and appliance subsystems. The embodiments thereby transform otherwise ordinary devices into agent-capable, voice-accessible, context-aware, and interoperable intelligent systems.

### Overview

One embodiment includes an intelligent bridge device that connects on one side to one or more physical things and on another side to one or more cloud-based intelligence services, including large language models, software agents, orchestration platforms, policy engines, or remote computing services.

The physical thing may be any electronic device, machine, appliance, instrument, controller, vehicle subsystem, peripheral, or embedded electronics assembly. The cloud-side intelligence may include a conversational agent, a developer-provided software agent, a supervisory agent, an enterprise automation system, a machine-control service, or combinations thereof. The bridge device may be portable, pluggable, wearable, stationary, or embedded as a module within another product.

The bridge device imparts agency to an otherwise non-agentic thing. A device that may previously have only exposed a port or radio interface becomes, through the bridge device, a discoverable, addressable, context-aware, conversationally controllable, and task-capable agent endpoint.

### Intelligent Bridge Architecture

In one embodiment, the bridge device includes a wide-area communication interface, such as LTE, NB-IoT, Cat-1, Cat-1 bis, 5G, RedCap, or successor wireless technologies; one or more local interfaces, such as USB host or device functionality, Bluetooth, BLE, Wi-Fi, Ethernet, serial, GPIO, I2C, SPI, CAN, or near-field communication; one or more processing elements; memory storing executable instructions; a microphone and speaker in voice-first embodiments; optional sensors; and security circuitry or software for identity, authentication, provisioning, and policy enforcement.

The bridge device may act as a local protocol mediator, identity endpoint detector, cloud relay, contextual sensor package, and agent runtime gateway. The bridge device may expose to remote agents an abstracted view of the connected thing while simultaneously translating between raw device protocols and higher-level intents or tool calls.

### Imparting Agency to a Thing

One aspect of the embodiments include the transformation of an otherwise ordinary thing into an agent-capable entity. This transformation may include one or more of interface discovery, protocol interrogation, model inference, driver or adapter generation, capability abstraction, task execution, natural interaction, context extension, and collaborative participation.

One embodiment may impart Model Context Protocol-type features to a thing to support its use by agents. Another embodiment, includes an agent, with practical intelligent agency imparted by the bridge device, not merely structured tools or context exposure. Thus, the bridge device does more than connect a device to the internet; it enables the thing to be represented and used as an active participant in a broader intelligent ecosystem.

### Automatic Discovery, Learning, and Interface Construction

In some embodiments, the bridge device automatically learns how to interact with a thing. This may be accomplished using one or more of enumeration of USB descriptors or classes, Bluetooth service discovery, Wi-Fi device identification, traffic observation, serial-console interrogation, manufacturer or model database lookups, retrieval of manuals or interface definitions, machine-learning inference over observed protocol exchanges, AI-based generation of command wrappers or application programming interfaces (APIs), and user-guided teaching.

Thus, the bridge device may construct a machine-usable interface even where no preexisting formal driver has been manually installed. This aspect is applicable for a variety of conventional electronic devices including for example, heterogeneous legacy equipment, one-off appliances, test instruments, routers, appliances, or devices for which the end user lacks technical setup expertise.

### Representative Example Embodiments

In one embodiment, a conventional printer is connected to the bridge device through USB, Bluetooth, Wi-Fi, or another local interface. The bridge device identifies the printer, determines supported functions, and establishes a cloud-linked representation of the printer as an addressable agent-enabled resource. A user may then interact with the printer through spoken language, and the bridge device or associated cloud intelligence may identify the requested printer, authenticate the requesting user, prepare a communication path, perform the print operation, and confirm success or troubleshoot failures conversationally.

In another embodiment, the bridge device is coupled to a home router, gateway, modem, or networking device via USB, Bluetooth, Wi-Fi, Ethernet, serial console, or other interface. The bridge device may interrogate the router, identify device state, observe connectivity conditions, retrieve or infer setup procedures, and coordinate with a cloud agent to perform guided or automated configuration or diagnostics.

In another embodiment, the bridge device is attached to or integrated with test equipment, such as a multimeter, oscilloscope, analyzer, environmental chamber, or other instrument. In addition to discovering the instrument interface and supported functions, the bridge device may contribute contextual sensing unavailable to the original equipment, such as ambient temperature, geolocation, motion or handling state, technician presence, and timestamps associated with the measurement.

### Dynamic Role Assignment, Morphable Identity, and Specialized Agent Operation

In some embodiments, the intelligent bridge device is not limited to a single fixed identity, function, or application domain. Rather, the bridge device may be selectively configured, reconfigured, or morphed into different operational roles depending on one or more factors, including the type of physical thing to which it is coupled, the communication interface being used, the sensors presently active or available, the environmental conditions detected by the device, the identity or capabilities of the agent currently in control, the developer-defined skill set or agent package available to the device, the permissions granted by a user or administrator, and the specific role requested by a user.

Accordingly, the same bridge device may operate at different times and in different contexts as entirely different kinds of intelligent systems, including by way of example a dog tracker, a child-monitoring device, a security sentinel, a mobile assistant, a maintenance assistant, an access-control tool, an industrial machine companion, a field-service assistant, or a conversational interface for a particular appliance, tool, or vehicle subsystem.

In some embodiments, such morphability is achieved through selective loading, activation, or handoff to one or more specialized agents. The transition may be triggered automatically based on contextual cues, such as location, motion, nearby devices, time of day, environmental sensing, detected equipment type, or observed user intent. Additionally or alternatively, the transition may be initiated by a user through a spoken request, touch interaction, application-based selection, administrative policy, or remote orchestration command.

This architecture differs from systems in which a single generalized agent is expected to perform adequately across a broad range of unrelated tasks. In contrast, the embodiments enable the bridge device to selectively invoke agents that are specially trained, fine-tuned, configured, or otherwise optimized for particular industries, equipment classes, knowledge domains, or workflows, including agents developed by third parties using proprietary materials, field-service notes, documents, simulation records, training corpora, or rule systems. Examples include a plumbing or building-services assistant that identifies boilers, pumps, valves, sensors, or manifolds and activates a domain-specific agent trained on installation procedures and maintenance records; and an oil-and-gas field assistant that communicates with pumps, valves, gauges, flow meters, gas detectors, telemetry units, and supervisory control equipment while using its own location, motion, and environmental sensors to assess site context and guide field personnel.

### The Bridge Device as a Key, Credential, and Capability-Unlocking Tool

In some embodiments, the intelligent bridge device functions not only as a communications bridge or agent interface, but also as a key, credential, authorization token, or unlock mechanism that enables access to one or more functions of a connected thing. In this sense, the bridge device may operate as a trusted intermediary that establishes identity, proves entitlement, negotiates permissions, and unlocks latent or restricted capabilities in the physical device, system, or environment with which it is associated.

When coupled to a router, appliance, machine, tool, vehicle subsystem, or other electronic device, the bridge device may authenticate itself to a remote service, authenticate the user to the bridge device, or authenticate the connected thing to a broader platform. Upon successful authentication, the bridge device may retrieve configuration data, software modules, operational permissions, or device-specific control rights that allow additional capabilities to become available.

In further embodiments, the bridge device may function in a manner similar to a vehicle key, key fob, or digital access credential. The bridge device may authenticate a user's authority to access, unlock, start, or otherwise operate a vehicle, and may further provide a conversational interface to vehicle systems, allowing requests such as starting the vehicle, unlocking a trunk, interfacing with navigation, retrieving vehicle status, adjusting cabin settings, initiating diagnostics, or coordinating with service agents.

In some embodiments, contextual or policy-based restrictions are applied before unlocking or authorizing actions. For example, the device may require physical proximity, recognized voice characteristics, a secondary authentication step, time-or place-based restrictions, or approval from a supervisory agent or policy server. Permissions may also be temporary, delegated, or revocable.

### Collaboration Among Things

In some embodiments, multiple bridge-equipped or bridge-accessible things may work together. A machine may coordinate with another machine, a sensor may inform an actuator, a garage controller may collaborate with a security system and a geolocation system, and test instruments may share results under supervision of a remote diagnostic agent. The bridge device may publish capabilities, discover nearby or remote companion devices, and allow one thing's agent representation to interoperate with another thing's agent representation locally, through the cloud, through direct device-to-device communication, or via supervisory orchestration.

### Supervisory Agent and Subordinate Agent Architecture

In some embodiments, the bridge device includes or is associated with a default supervisory agent, which can serve as a manager, front-end assistant, and session coordinator. The supervisory agent may receive initial user requests, authenticate or identify the user, determine whether the request should be handled directly or delegated, discover and broker access to specialized subordinate agents, maintain session context, manage permissions, arbitrate handoff between agents, and return control to itself after completion of a delegated interaction.

The embodiments further include a platform in which third-party developers create specialized named agents, each having distinct skills, personalities, permissions, and voice characteristics. A user may directly invoke a subordinate agent by name or may ask the supervisory agent to locate and connect the user with a suitable subordinate agent from among a plurality of registered agents.

### Agent Session Management and Identity Separation

A technical challenge addressed by the embodiments include reducing or avoiding confusion between the supervisory agent and subordinate agents, both for the user and for the intelligent device system. Accordingly, in some embodiments the bridge device implements agent session management, including explicit designation of the currently active agent, session-level state tracking, handoff markers, wake-name or invocation disambiguation, voice differentiation among agents, timeout rules, session transfer back to the supervisory agent, interrupt handling, user-command based agent dismissal, and permission revocation.

To reduce or avoid ambiguity as to which agent is speaking, subordinate agents may be required or encouraged to use distinct output voices, speech styles, chimes, names, personas, or interaction patterns. In some embodiments, the user interface explicitly announces or otherwise indicates current-agent identity.

### Voice-First Interaction, Speaker Attribution, and Shared-Environment Control

In voice-first embodiments, the intelligent bridge device includes a microphone, speaker, and audio-processing pipeline configured to allow direct spoken interaction between one or more users and the device, the supervisory agent, and/or one or more subordinate agents. The voice interaction may be local or cloud-assisted, single-agent or multi-agent, wake-word based, touch initiated, button initiated, proximity initiated, gesture initiated, or always listening within defined policy constraints.

In practical deployments, the bridge device may be used in homes, offices, vehicles, workshops, industrial settings, healthcare settings, retail spaces, and other locations in which more than one person may be present, speaking, or attempting to interact with the device. Such environments create technical challenges including speaker ambiguity, accidental activation, overlapping speech, unauthorized commands, spoofed or imitated voices, privacy concerns, and uncertainty as to which user should be treated as the active or controlling user at a given moment.

In some embodiments, the bridge device determines an active user or current speaker of record for a session based on one or more factors including touch or grasp of the device, proximity of a speaker to the microphone array, direction-of-arrival or beamforming analysis, recognized voice characteristics, prior session continuity, possession of a trusted companion device, recent successful authentication, location context, explicit user invocation, or administrative policy.

Speaker recognition may be treated as one factor within a broader confidence framework rather than as a sole proof of identity. When multiple users are detected, or when the active speaker cannot be determined with sufficient confidence, the bridge device may automatically enter a shared-environment mode, restricted mode, or lower-trust mode. In such a mode, one or more security-sensitive functions may be limited until clearer user attribution is established.

For example, the bridge device may disable or suppress certain subordinate agents, restrict access to personal data, refuse to perform privileged actions, require touch initiation before accepting commands, require a confirmation phrase or second factor, provide only general informational responses, withhold spoken output of sensitive information, redirect sensitive responses to a trusted secondary device, or ask which user is speaking before proceeding.

### Security and Authentication

The intelligent bridge device is configured to support a voice-first security and authentication framework adapted to the requirements of an always-available, conversational, agent-mediated device. Because the bridge device may be used not only for general conversation but also for access to personal information, control of connected things, financial actions, communications on behalf of a user, and other sensitive operations, the embodiments include a multi-layered authentication and authorization architecture in which security requirements vary based on context, requested action, active agent, and degree of risk.

In one embodiment, authentication may be initiated primarily through voice interaction, optionally combined with one or more secondary or tertiary factors. The bridge device may therefore support authentication methods including spoken challenges, rotating passcodes, one-time spoken codes, trusted-device interaction, proximity validation, voiceprint recognition, behavioral profiling, biometric confirmation using external devices, hardware-backed root-of-trust validation, cryptographic token exchange, and combinations thereof.

In some embodiments, user interactions and agent actions are classified into multiple security layers. A first layer may include low-risk interactions that do not require access to private or high-value information and do not permit consequential action on behalf of the user. A second layer may include interactions involving personal information, account-linked services, protected preferences, device histories, home status, messages, location history, or operation of personal but non-critical systems. A third layer may include actions of substantially higher consequence, such as financial activity, communications on behalf of the user, granting or revoking access rights, or control of security-critical systems or vehicles.

For the second layer, the supervisory agent may trigger a higher-security challenge when an agent seeks access to elevated information or privileges. The bridge device may send a one-time code, phrase, or approval token to another trusted device or service, such as a mobile phone, email account, desktop computer, television, wearable, smart display, or household authentication terminal. The user may then speak the received code to the bridge device while maintaining a voice-first interaction model.

In some embodiments, the second factor need not be a conventional phone-centered workflow. The user may elect a time-bounded daily secret, such as a word-of-the-day, phrase-of-the-day, image cue, or code phrase delivered once each morning to another trusted device not ordinarily carried throughout the day. The secret may expire after one use, after a defined time interval, at the end of the day, or upon detection of suspicious activity.

For the third layer, security may be established using a combination of lower-layer methods plus one or more additional trust factors, such as interaction with an external biometric device, facial recognition terminal, fingerprint reader, hardware token, trusted wearable, smart card, cryptographic authenticator, local secure enclave, passkey-enabled companion device, or another hardware-backed root-of-trust system. In some embodiments, a high-risk action requires real-time collaborative approval between the bridge device and a separate trusted verifier device.

Because the bridge device may operate with multiple agents, the invention preferably distinguishes between user authentication and agent authorization. Each agent may be associated with a permission scope, trust profile, and action class. The supervisory agent may act as a security broker, deciding whether to allow a request directly, require re-authentication, require user confirmation, require a second-device check, deny the action, or escalate the request to a higher-trust mode. In some embodiments, subordinate agents never directly receive the user's full credentials, but instead receive temporary scoped tokens, action-limited permissions, or time-bounded session grants.

In some embodiments, authentication is progressive rather than binary. A session may begin in a low-trust conversational state and increase in trust as the user successfully completes challenges or demonstrates possession of trusted factors. Trust may decay over time if sufficient time passes, the device changes location, a different voice is detected, a new agent takes control, the requested action is materially more sensitive than prior actions, or the system detects signs of attack, confusion, or misuse.

At any time, a user may revoke an agent's authority, such as by instructing the bridge device system to fire, disconnect, or disable an agent. In response, the bridge device system may revoke credentials, invalidate tokens, terminate sessions, delete stored authorization artifacts, remove agent bindings, or modify permissions such that the agent can no longer act for that user, access that user's information, or control any associated connected thing.

### Sensor-Based Context Extension

A further feature of the invention is that the bridge device may add contextual intelligence to a connected thing through local sensing. Examples include GPS or GNSS location, enabling location-aware operation; motion or inertial sensing, enabling awareness of transport, handling, vibration, falls, or unauthorized movement; temperature or environmental sensing, enabling condition monitoring; proximity or touch sensing, enabling user-presence detection; and audio sensing, enabling voice interaction, sound event recognition, or environmental interpretation.

Thus, even if the connected thing itself lacks such sensors, the bridge device may effectively augment the thing's knowledge of the real world.

### Embedded and Modular Embodiments

The embodiments are not limited to a standalone and/or external device. In some embodiments, the bridge functionality is embedded into a host appliance, a module within a printer, router, or machine, a dongle or accessory, a wearable device, a vehicle subsystem, a smart-home node, a manufacturing tool, a shipping or logistics device, or another electronic assembly. Thus, the embodiments can be implemented in and/or as a consumer device, enterprise accessory, original equipment manufacturer (OEM) module, industrial retrofit component, or integrated subsystem.

### Embodiments and Features

One embodiment includes a method comprising coupling an intelligent bridge device to a thing through at least one local communication interface; detecting, interrogating, or identifying the thing; connecting the bridge device to a remote intelligence platform through a wide-area network; determining one or more capabilities of the thing; generating, selecting, or exposing an agent-usable interface corresponding to the thing; receiving a user request or agent-originated task; authenticating the request; causing the thing to perform one or more actions, via the conventional communication interface of the thing; optionally augmenting the action using sensor-derived contextual information; and reporting a result, status, or conversational response.

In multi-agent embodiments, the method may further include receiving a request directed to a subordinate agent, establishing an agent session under supervision of a default supervisory agent, handing off context, permissions, and identity tokens, monitoring the subordinate-agent session, and restoring control to the supervisory agent upon completion, interruption, timeout, or revocation.

Some embodiments include AI-generated tool schemas for physical devices, policy-based action guardrails, local fallback intelligence when cloud connectivity is degraded, audit trails and explainability, identity portability across bridge devices, shared thing profiles, registries or marketplaces of agent-capable things, duress phrases for protective security responses, and physical-world sensing as an agent input layer.

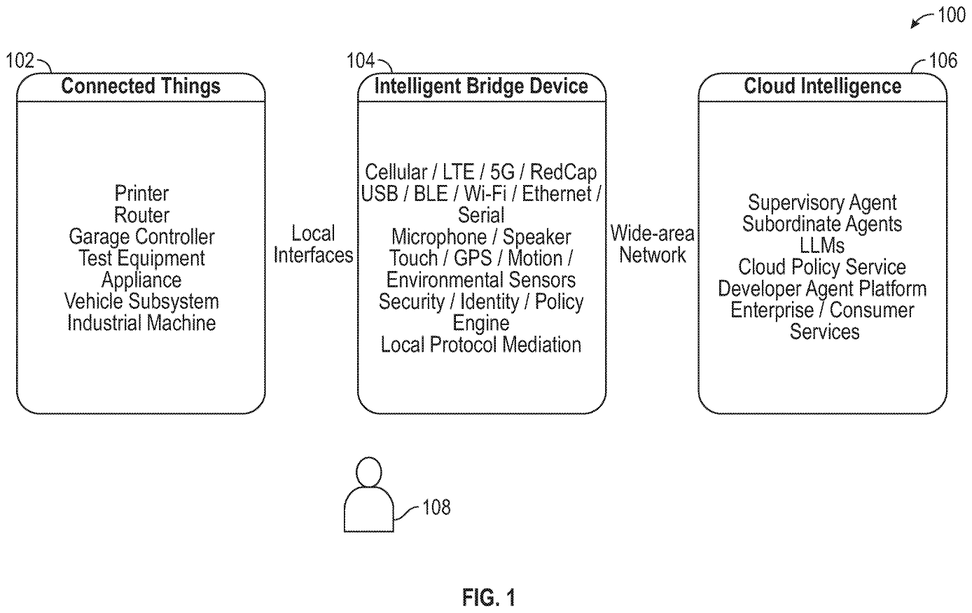

FIG. 1 illustrates an example of an intelligent bridge device system architecture 100, according to an embodiment. Connected things 102 can include a conventional electronic device, lacking wireless communication and/or artificial intelligence (AI) features. For example, the thing may have been manufactured, assembled and/or otherwise constructed before the advent and prevalence of AI, thus lacking those features. The thing may also lack wireless communication interfaces. The thing does however include a local communication interface, for local communication with an external device. Example local communication interfaces include universal serial bus (USB) and others. The intelligent bridge device 104 can include wireless communication features, and hardware to enable it to interface with cloud intelligence 106 and/or user 108.

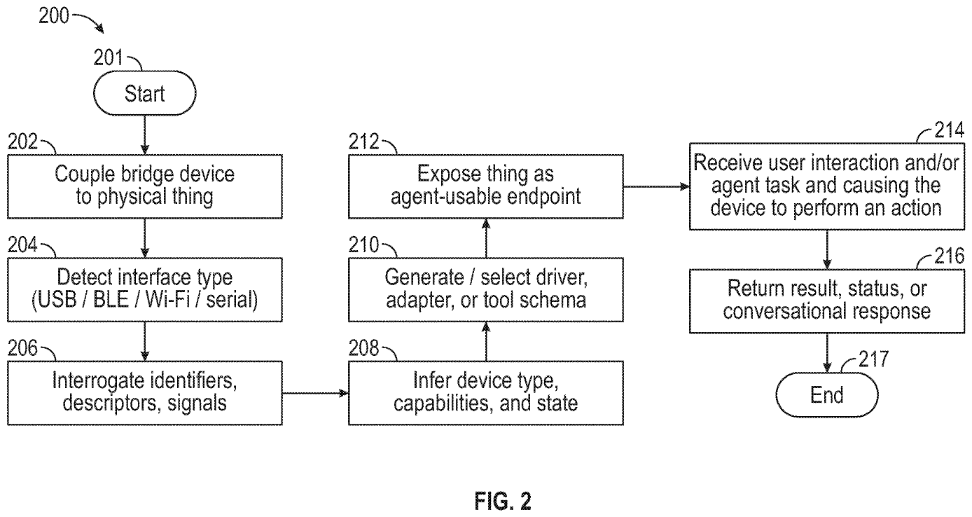

FIG. 2 illustrates a diagram 200 of operations of automatic discovery and agent enablement flow for a connected thing, according to an embodiment. The method starts at step 201. Step 202 includes coupling a bridge device to a thing. Coupling can include making a physical connection to a communication interface of the thing. Step 204 includes detecting the communication interface type of the thing. Step 206 includes interrogating identifiers, descriptors and signals of the thing. Step 208 includes inferring device type, device capabilities, and device state. “Device” in this context refers to the thing. Step 210 includes generating and/or selecting driver, adaptor or tool schema that enables the bridge device to communicate with the thing and/or trigger or cause the thing to perform and action. Step 212 includes making the thing available as an agent-usable endpoint, at least in part based on the type of the device, its capabilities, state and other characteristics of the thing. Step 214 includes receiving a user interaction and/or an agent task and causing the thing to perform an action corresponding to the user interaction and/or the agent task. Step 216 includes returning a result, or a conventional response from the thing. The method ends at step 217.

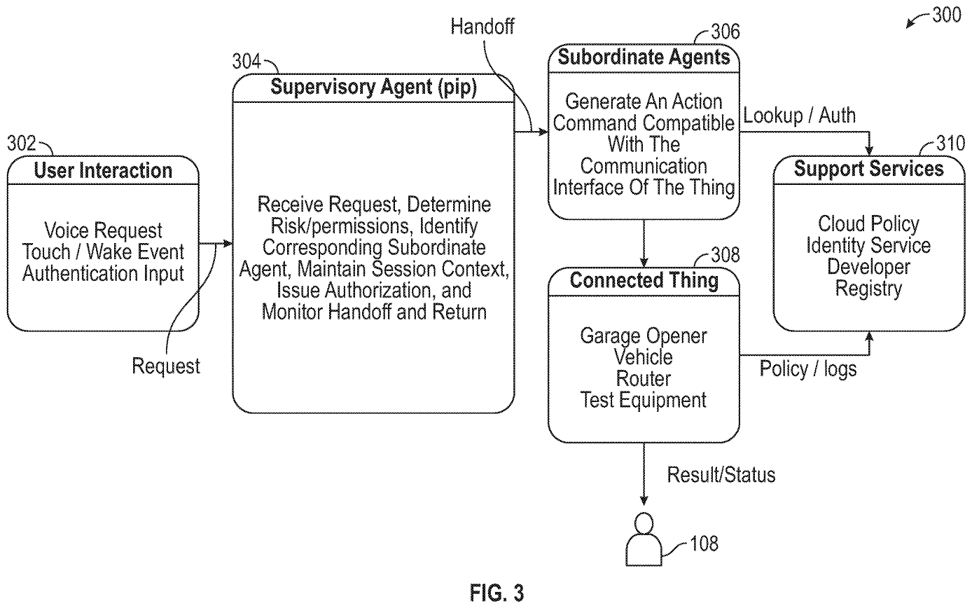

FIG. 3 illustrates a diagram 300 of operations of a supervisory agent and subordinate agent handoff, according to an embodiment. User interactions 302 can include the user issuing a voice command, touching a touch screen interface of the thing (and/or in some embodiments the bridge device), or otherwise causing a wakeup event in the thing and/or the bridge device, and providing an authentication input. The user interaction 302 can include a request. A supervisory agent 304, sometimes referred to as Pip, can perform operations, such as receive the request, determining risk/permissions, identifying corresponding subordinate agent, maintaining session context, issuing authorization, and monitoring handoff and return.

The supervisory agent 304 can handoff the request and/or session to one or more subordinate agents 306. The subordinate agents 306 can generate an action command compatible with the communication interface of the thing. The thing 308 can perform the action command and return a result, status, conventional response and/or an output to the user 108. The subordinate agents 306 can also communicate with support services 310, for example by issuing lookup requests, or authorization requests. The thing can also communicate with support services 310, for example by issuing policy requests or sending logs.

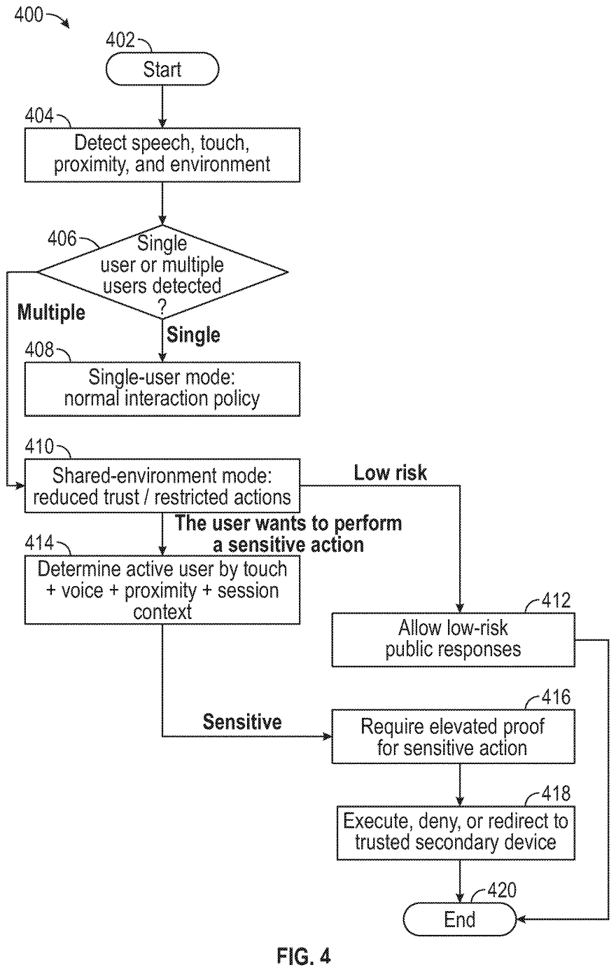

FIG. 4 illustrates an example diagram 400 of a multi-user voice interaction and shared environment control flow. The method starts at step 402. Step 404 includes detecting a user input indication, such as speech, touch, proximity, or an environmental factor. Step 406 includes determining whether the user input indication corresponds to a single user or multiple users. If a single user is detected, the method moves to step 408 by executing the single-user mode and applying a single user or normal user interaction policy. If multiple users are detected, the method moves to step 410 by executing a shared environment mode. The shared environment mode can include associated restrictions or features such as reduced trust or only allowing a restricted set of actions. When the user input indication signal does not include a request for a sensitive action, the method moves to step 412 and allows low-risk public responses. When the user input indication signal does include a request for a sensitive action, the method moves to step 414. Step 414 includes determining an active user, based on analyzing the data in the user input indication signal. For example, an active user can be determined based on the user's touch, voice, proximity, session context, or a combination of these factors. The sensitive request is routed and at step 416, the method issues a security request for an elevated proof for the sensitive action. Step 418 includes executing the user request, denying it, or redirecting it to a trusted secondary device. The method ends at step 420.

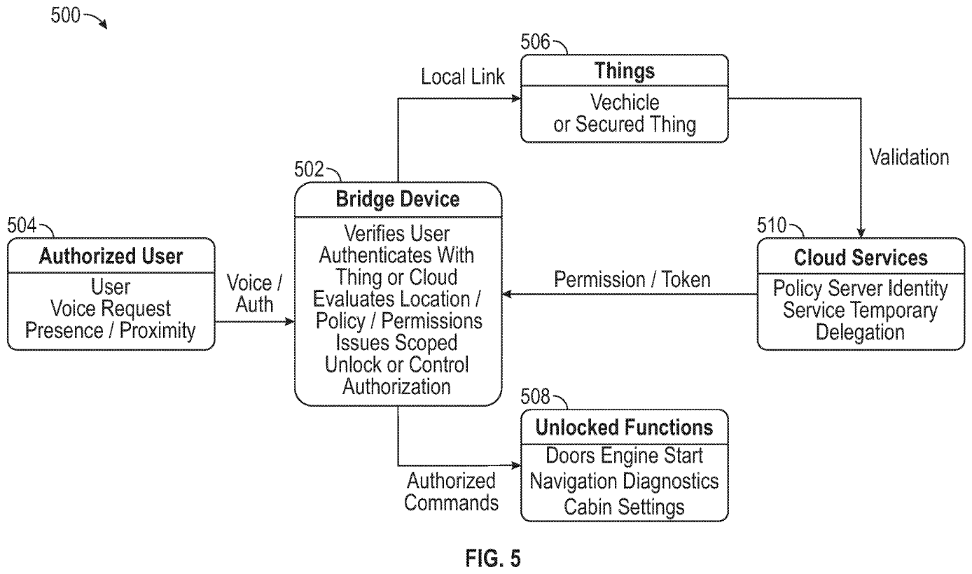

FIG. 5 illustrates a diagram 500 of the operations of embodiments utilizing a key and credential technique for unlocking capabilities of an electrical device. The bridge device 502 can receive a user input, for example user voice or an authentication signal or data. The authentication signal can include the user's voice or specific phrases spoken by the user and in the user's voice, or environmental factors, such as presence and proximity. The bridge device 502 can verify the user, authenticate the user with the thing or cloud services 510. The bridge device 502 can further perform evaluation of location, obtaining policy and permissions. The bridge device 502 can issue a scoped unlock or control authorization, and send a local link to the thing, containing the user's credentials. In other words, the bridge device can generate a data structure of users'credentials, for example as a local link, which the bridge device can send to the thing. The thing, in this example, can be a vehicle or any secured thing. The thing 506 can send a validation request, at least partly based on the user's credentials (e.g., local link) to the cloud services 510. The cloud services 510 can included a policy server identify service and protocols for temporary delegation. The cloud services can analyze user's credentials and send a permission token to the bridge device. Upon receiving the permission or token, the bridge device can send the authorized user request or commands to the unlocked functions 508 of the thing.

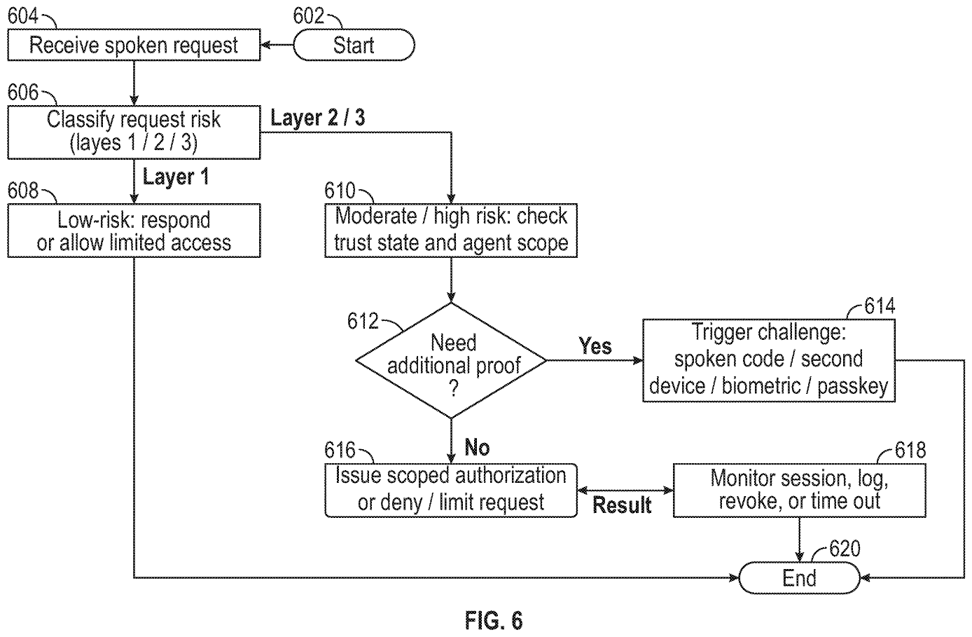

FIG. 6 illustrates a flowchart of an example method 600 of voice-first security and authentication operations. The method starts at step 602. Step 604 includes receiving a user request in the form of voice or a spoken request. Step 606 includes classifying the request risk. In one embodiment, a three layer risk profile can be used for classification, where a first layer is applied when the request is deemed low risk, for example, when the request targets a non-critical function in the thing or requests unsecured data or function, not subject any security or authentication regime of the thing. Second and third layer risk profiles include moderate or higher risk requests, based on the nature and context of the user request. At step 610, for moderate or high risk profile requests, the method checks trust state of the user and/or the request and a corresponding agent scope that can safely service the request, without exposing the thing to security breaches. Step 612 includes determining whether additional proof is needed before authentication. If yes, the method moves to step 614 and a trigger challenge is issued. Some example trigger challenges can include spoken code, second device authentication (e.g., two-factor authentication), biometrics or passkey. If no additional proof is needed, the method moves to step 616, and issues a scoped authorization or deny or limit the request as the case may be. Step 618 includes monitoring the session and its logs, and revoking the issued authorization, based on the security policies of the thing for the appropriate level of risk profile. The method ends at step 620.

### EXAMPLES

It will be appreciated that the present disclosure may include any one and up to all of the following examples.

Example 1: A voice-first intelligent bridge device for enabling user access to multiple software agents, the device comprising: a microphone; a speaker; a wide-area wireless interface; at least one processor; and memory storing instructions that, when executed by the at least one processor, cause the device to: receive spoken input from a user; identify, select, or connect the user to one of a plurality of software agents, including a supervisory agent and one or more subordinate agents; establish an agent session corresponding to a selected software agent; route audio interactions between the user and the selected software agent; distinguish the selected software agent from at least one other software agent during the agent session; and return control to the supervisory agent upon completion, interruption, timeout, revocation, or user request.

Example 2: The device of Example 1, wherein the device is configured to revoke authority of one of the subordinate agents in response to a spoken command from the user.

Example 3: The device of any of Examples 1 and 2, wherein the spoken command comprises a dismissal instruction directed to the subordinate agent.

Example 4: The device of any of Examples 1-3, wherein the device is configured to share a scoped identifier, scoped credential, or time-limited token with a selected subordinate agent while withholding one or more other credentials from the selected subordinate agent.

Example 5: The device of any of Examples 1-4, wherein the device is configured to determine whether multiple users are present and, in response, reduce available privileges, require additional authentication, or restrict one or more subordinate agents.

Example 6: The device of any of Examples 1-5, wherein the device is configured to determine an active user based on at least one of touch, voice characteristics, proximity, direction-of-arrival analysis, session continuity, or possession of a trusted companion device.

Example 7: The device of any of Examples 1-6, wherein the device is configured to provide access to software agents developed by different third parties and having different proprietary training data, knowledge domains, or action capabilities.

Example 8: A method for imparting agent functionality to a physical thing using an intelligent bridge device, the method comprising: coupling the intelligent bridge device to the physical thing through at least one local interface; detecting the physical thing; determining one or more capabilities of the physical thing; connecting the intelligent bridge device to a remote intelligence platform through a wide-area network; constructing, selecting, or exposing an agent-usable representation of the physical thing; receiving, by the intelligent bridge device, a request from a user or a software agent; and causing the physical thing to perform an action or provide information in response to the request.

Example 9: The method of Example 8, further comprising augmenting the request or the action using sensor-derived contextual information obtained by the intelligent bridge device.

Example 10: The method of any of Examples 8 and 9, wherein receiving the request comprises receiving a spoken request through a microphone of the intelligent bridge device.

Example 11: The method of any of Examples 8-10, further comprising determining whether the spoken request is associated with a low-risk action, a moderate-risk action, or a high-risk action.

Example 12: The method of any of Examples 8-11, further comprising, based on the determined risk, requiring at least one of a spoken challenge response, a one-time code, a trusted secondary device confirmation, a biometric confirmation, a passkey confirmation, or a cryptographic verification.

Example 13: The method of any of Examples 8-12, further comprising determining that multiple users are present and, in response, entering a restricted interaction mode.

Example 14: The method of any of Examples 8-13, wherein the restricted interaction mode comprises requiring touch input before permitting a privileged action.

Example 15: The method of any of Examples 8-14, further comprising: receiving a request directed to a subordinate software agent; establishing a subordinate-agent session under supervision of a supervisory agent; passing session context and scoped permissions to the subordinate software agent; and restoring control to the supervisory agent after completion of the subordinate-agent session.

Example 16: The method of any of Examples 8-15, wherein the physical thing comprises at least one of a printer, router, appliance, garage door controller, test instrument, industrial machine, vehicle, vehicle subsystem, or building system.

Example 17: The method of some or all of Examples 8-16, further comprising dynamically reconfiguring the intelligent bridge device into one of a plurality of operational roles based on the physical thing, environmental context, available software agent, or user request.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including, hard drives, floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects.

What is claimed is:

1. An intelligent bridge system for imparting agent functionality to an electronic device, comprising:
an intelligent bridge device comprising:
a wide-area network interface configured to communicate with a remote computing system over a cellular network or other wide-area network;
at least one local interface configured to couple and communicate with a corresponding local communication interface of an electronic device;
at least one processor and memory storing instructions that, when executed by the at least one processor, cause the intelligent bridge device to:
detect the electronic device through the at least one local interface;
determine one or more capabilities of the electronic device;
communicatively couple the electronic device to one or more remote software agents, large language models, cloud services, or combinations thereof through the wide-area network interface;
generate, select, or expose the electronic device as an artificial intelligence agent-usable interface corresponding to the electronic device;
receive one or more user input signals, related to or corresponding to a functionality of the electronic device; and
control the electronic device as an agent endpoint, based at least in part on the user input signal.

2. The system of claim 1, wherein the local interface comprises at least one of USB, Bluetooth, Wi-Fi, Ethernet, serial, GPIO, I2C, SPI, CAN, or near-field communication.

3. The system of claim 1, wherein determining the one or more capabilities of the electronic device comprises at least one or more of
interrogating descriptors of the electronic device, performing protocol discovery, observing communications traffic, identifying a type of the electronic device, inferring a command structure, retrieving device-specific information, and generating a driver, wrapper, adapter, or tool schema.

4. The system of claim 1, wherein the intelligent bridge device further comprises at least one sensor configured to detect environmental or contextual information associated with the electronic device.

5. The system of claim 4, wherein the at least one sensor comprises one or more of a GPS sensor, GNSS sensor, microphone, accelerometer, gyroscope, temperature sensor, humidity sensor, light sensor, proximity sensor, touch sensor, and pressure sensor.

6. The system of claim 4, wherein the instructions further cause the intelligent bridge device to augment operations of the electronic device, at least in part based on using environmental or contextual information, based on data from the sensor.

7. The system of claim 1, wherein the intelligent bridge device is configured to selectively expose different capabilities of the electronic device to one or more software agents based on permissions, policy, or user identity.

8. The system of claim 1, wherein the intelligent bridge device is a conduit for collaboration between the electronic device and at least one additional electronic device through agent-mediated coordination.

9. The system of claim 1, wherein the intelligent bridge device is configured to function as a key, credential, authorization token, or capability-unlocking intermediary for the physical thing.

10. The system of claim 9, wherein the electronic device comprises a vehicle or vehicle subsystem, and wherein the intelligent bridge device is configured to authorize at least one of door unlocking, ignition trigger, engine start, navigation interaction, diagnostics access, or cabin setting control.

11. The system of claim 1, wherein the intelligent bridge device is a portable, wearable, pluggable, or embedded as a module in a product.

12. The system of claim 1, wherein the agent-usable interface comprises a callable tool interface, application programming interface, machine-readable schema, or protocol translation layer representing capabilities of the electronic device.

13. The system of claim 1, wherein the intelligent bridge device is configured to dynamically assume different operational roles based on one or more attributes of the electronic device, the one or more attributes comprising: an environment, an available agent, a user request, an active sensor set, or an applied permission policy.

14. The system of claim 13, wherein the different operational roles comprise at least two roles selected from a tracking role, security role, maintenance role, field-service role, appliance-control role, vehicle-access role, child-monitoring role, or industrial-assistant role.

15. A voice-first intelligent bridge device for enabling user access to multiple software agents, the device comprising:
a microphone; a speaker; a wide-area wireless interface;
at least one processor; and memory storing instructions that, when executed by the at least one processor, cause the device to:
receive spoken input from a user;
identify, select, or connect the user to one of a plurality of software agents, including a supervisory agent and one or more subordinate agents;
establish an agent session corresponding to a selected software agent;
route audio interactions between the user and the selected software agent;
distinguish the selected software agent from at least one other software agent during the agent session; and
return control to the supervisory agent upon completion, interruption, timeout, revocation, or user request.

16. The device of claim 15, wherein the instructions further cause the device to receive a spoken request directed to a named software agent and to locate the named software agent from among a plurality of registered software agents.

17. The device of claim 15, wherein the supervisory agent is configured to route the user request, based on whether the request is to be handled directly by the supervisory agent or handed off to one of the subordinate agents based on subject matter, permissions, trust level, or agent capability.

18. The device of claim 15, wherein the instructions further cause the device to distinguish among the software agents by at least one of different synthesized voices, different spoken introductions, different chimes, different names, different personas, or different session indicators.

19. The device of claim 15, wherein the instructions further cause the device to manage agent-specific permissions such that a first subordinate agent is permitted to perform a first class of actions and a second subordinate agent is permitted to perform a different class of actions.

20. The device of claim 15, the instructions further cause the device to revoke authority of one of the subordinate agents in response to a spoken command from the user.
